(19) United States
(12) Patent Application Publication
(10) Pub. No.: US 2013/0155697 A1
(43) Pub. Date: Jun. 20, 2013

(54) SYSTEM FOR LED COOLING

(71) Applicant: Flemming Dahlin, Graested (DK)

(72) Inventor: Flemming Dahlin, Graested (DK)

(73) Assignee: WISE INNOVATIONS TECHNOLOGIES SARL, Luxembourg (LU)

(21) Appl. No.: 13/703,535

(22) PCT Filed: Jun. 10, 2011
(86) PCT No.: PCT/DK2011/050206

§ 371 Date: Feb. 21, 2013

(30) Foreign Application Priority Data
Jun. 11, 2010 (DK) PA 2010 70257

(51) Int. Cl. F21V 29/00; F21V 15/015

(52) U.S. Cl. CPC F21V 29/002; F21V 29/22; F21V 15/015; F21V 29/004
USPC 362/373; 362/382

(57) ABSTRACT

An LED cooling system includes a plate, the plate includes a plurality of slots for positioning a plurality of LEDs and at least one gap for substantially isolating each of the plurality of LED slots from one another such that heat from each of the plurality of LEDs has at least one non-interfering path towards an edge of the plate, thereby heating of one LED is substantially uninfluenced by heating of other LEDs in the plurality of LEDs.

### FIELD OF THE INVENTION

The present invention relates to Light Emitting Diode (LED) lights. In particular, the invention relates to a system for cooling LED, which produces substantial heat during operation.

### BACKGROUND OF THE INVENTION

High luminosity, bright colours, variety in light source combinations, and low power consumption are features of and reasons for the popularity of light emitting diodes (LED). In general, the colour changes and combinations are achieved by passing electric currents and pulses through three basic colours of red, blue and green to generated multifarious light sources unsurpassed by other light sources or lighting devices. Moreover, through various combinations of colours and changes in luminosity, a dynamic lighting effect can be achieved. Therefore, LEDs are widely used in all kinds of display devices, visible light projectors and decorating devices.

However, LEDs have the problem of poor heat dissipation. In addition, illumination decreases as the ambient temperature rises. Over-driving the LED in high ambient temperatures may result in overheating of the LED unit. To keep a high illumination efficiency of LEDs, therefore, their own temperature must be kept low.

Some prior art apparatus have used LEDs to generate a desired light output for a lighting requirement. Such LEDs typically generate so much heat that a heat sink is required. Until now, the prior art solutions have struggled to satisfy the requirement of an adequate heat sink or cooling system for LED applications, especially in a high intensity LED light generation or in light equipments requiring weather sealing.

Another heat dissipation problem occurs when a multitude of LEDs are used. These LEDs are generally arranged in different patterns where one LED typically is in physical proximity of other LEDs. This results in an additive interfering heat load at one LED because of its surrounding LEDs, thereby limiting the operational efficiency of the LED device.

The present invention discloses a novel LED cooling system for dissipating/transferring heat. This system allows for improved performance of LEDs in architectural, entertainment and other lighting applications such as in portable lighting units like torch.

### SUMMARY OF THE INVENTION

According to an embodiment of the invention, an LED cooling system is disclosed. The cooling system includes a plate, the plate includes a plurality of slots for positioning a plurality of LEDs and at least one gap for substantially isolating each of the plurality of LED slots from one another such that heat from each of the plurality of LEDs has at least one non-interfering path towards an edge of the plate, thereby heating of one LED is substantially uninfluenced by heating of other LEDs in the plurality of LEDs.

According to another embodiment of the invention, a cover for cooling LED is disclosed. The cover includes a first cover and a second cover. The second cover is fixedly placed over a part of a length of the first cover, at a radial distance from the first cover, thereby defining a radial region between the first cover and the second cover along the part of the length, the radial region defining at least one vent.

According to yet another embodiment of the invention, an LED cooling system is disclosed. The system includes a plate having a slot for positioning an LED and a cover comprising a first cover and a second cover. The second cover is fixedly placed, over a part of a length of the first cover, at a radial distance from the first cover, thereby defining a radial region between the first cover and the second cover along the part of the length, the radial region defining at least one vent. The heat generated by the LED has at least a non-interfering path towards the first cover.

According to yet another embodiment of the invention, a high intensity LED lighting unit is disclosed. The unit includes an array of LED lighting units, wherein each LED lighting unit includes a plate having a plurality of slots for positioning a plurality of LEDs, a cover comprising a first cover and a second cover, wherein the second cover is fixedly placed over a part of a length of the first cover, at a radial distance from the first cover, thereby defining a radial region between the first cover and the second cover along the part of the length, the radial region defining at least one vent; and the heat generated by the LED has at least a non-interfering path towards the first cover.

### BRIEF DESCRIPTION OF ACCOMPANYING DRAWINGS

The embodiments of the invention, together with its advantages, may be best understood from the following detailed description taken in conjunction with the accompanying figures in which:

FIG. 1 illustrates an LED cooling system according to an embodiment of the invention;

FIG. 2 illustrates the LED cooling system according to an embodiment of the invention;

FIG. 3 illustrates a cross section of the LED cooling system according to an embodiment of the invention; and

FIG. 4 illustrates the gap according to various embodiments of the invention. FIG. 4a illustrates an air gap according to an embodiment of the invention. FIG. 4b illustrates a gap with filled in secondary material according to an embodiment of the invention. FIG. 4c illustrates a cross-section of a gap, which is a depression in the plate, according to an embodiment of the invention. FIG. 4d illustrates a cross-section of a gap, which is a depression in a multi-layered plate, according to an embodiment of the invention.

### DETAILED DESCRIPTION OF THE INVENTION

For illustration purpose, the cooling system is shown in relation to a light emitting end of a torch. However, the person skilled in the art would appreciate that application of this invention in other applications such as in architectural lighting, traffic lights etc. are within the scope of this invention.

### DEFINITIONS

Radial region: is defined by the volumetric space enclosed between a first cover and a second cover. The second cover is positioned over a part of a length of the first cover and at a radial distance from the first cover. The length of the second cover defines the length of the radial region. In an embodiment, the first cover and second cover are concentric cylinders of different radii, wherein the radius of the first cover is smaller than that of the second cover. The difference in the radii of the second cover and the first cover defines the radial distance.

Vent: is defined by division of the radial region into a number of sub-radial regions. The division is along the length and parallel to a longitudinal axis of the second cover. Although the cooling system may include only one vent but more than one vent is usually preferred for achieving higher venting efficiency. The vent allows for air/fluid flow from one longitudinal end of the second cover towards the other longitudinal end of the second cover.

LED area: is defined by a plate area immediately proximate to an LED and includes the plate area where the temperature of the plate increases appreciably because of the operation of the LED.

Heat flow path or direction of flow of heat in the plate is defined by the movement or flow of heat from higher temperature (at LED/LED area) towards low temperature (at the edge of the plate) in order to achieve thermal equilibrium.

Non-interfering path: is defined by a heat flow path from the LED/LED area, through the thermally conducting plate, towards the edge of the plate whereby heat flow path of one LED/LED area is not crossed over by the heat flow path of the another LED/LED area. Therefore, heating of one LED/LED area is substantially reduced such as by 25%, 50%, 75% and even substantially uninfluenced by the heating of other LEDs/LED areas, thereby substantially reducing the possibility of LED failure because of overheating.

Heat or thermal conductivity is used in its conventional meaning, i.e. the quantity of heat transmitted through a unit thickness. Heat conductivity may also be denoted by heat transfer coefficients.

Gap: is defined, in one embodiment, by an air opening in the plate. In another embodiment, the gap may include a secondary material instead of the air gap, which has a lower heat conductivity than that of air in a given application or requirement. In yet another embodiment, the gap includes a depression in the plate, whereby the thickness of the plate is substantially reduced along the width of the depression. This ensures that the heat carrying capacity of plate is substantially reduced across the width because of the reduced thickness of the plate along the width of the depression. In a further embodiment, the plate is made up of two materials across its thickness, where one material has substantially higher thermal conductivity relative to the other. The gap includes a depression across the entire thickness of the material having substantially higher thermal conductivity. In yet another embodiment, the air may be replaced by gases like Argon, showing lower thermal conductivity than air.

The gap substantially reduces the flow of heat from the LED/LED area across the gap and thus, allows heat flow path only through the pate, which is made up of a material having a high thermal conductivity or heat carrying capacity, which is significantly higher in comparison to that of the air, secondary material, plate of reduced thickness or plate of material having substantially reduced thermal conductivity.

Heat Transfer from LED

The heat generated during the operation of a plurality of LEDs at the LEDs and their respective LED area is directed towards an edge of a plate on which the plurality of LEDs is positioned. The heat transfer from the LED/LED area towards the edge of the plate is because of the temperature difference between the LED/LED area, which has a higher temperature in comparison to the temperature at the edge of the plate.

Each of the plurality of LEDs is substantially isolated from one another by at least one gap, which in one embodiment is defined by an air gap in the plate. Because there is no convection in the gap, the air acts as a thermal insulator. The gap, therefore, substantially reduces the flow of heat from the LED/LED area across the gap and thus, allows flow of heat substantially only through the plate, which is made up of a material having high thermal conductivity and has significantly higher thermal conductivity in comparison to that of air. Because the gap substantially thermally isolates one LED/LED area from another, and in some embodiments surrounds the LED/LED area for such isolation, the additive interfering heat load at one LED/LED area because of other LEDs is eliminated. Therefore, the gap in conjunction with the thermally conducting plate allows LED/LED area to manage its own temperature only. The isolation of one LED from another using the gap provides each LED/LED area with at least one non-interfering heat flow path, which allows for flow of heat from the LED/LED area, through the thermally conducting plate, towards the edge of the plate whereby heat flow path of one LED/LED area is not crossed over by the heat flow path of the another LED/LED area. In other words, the temperature of one LED/LED area is uninfluenced by the temperature of other LEDs/LED areas of the plurality of LEDs.

The edge of the plate sits within a cover, which includes a first cover and a second cover. Therefore, the edge of the plate is in thermal contact with at least one vent, which is formed by the interaction between the first cover and the second cover, as described later in the description. The at least one vent allows flowing of ambient air/fluid through itself. Because the edge of the plate is tightly adjacent to the at least one vent; therefore, the heat accumulated at the edge of the plate is transferred and taken away by the air/fluid, flowing through the at least one vent, to the environment.

The heat is regularly generated at the LED/LED area and at the same time, the heat is being continuously transferred from the edge of the plate to the environment because of the air/fluid flowing through the at least one vent. Therefore, there always exists a thermal disequilibrium between the hotter LED/LED area and cooler edge of the plate, leading to a continuous transfer of heat from the LED/LED area to the environment in accordance with the following steps:
Heat from the LED/LED area flows along non-interfering heat flow path towards the edge of the plate; and
Heat accumulated at the edge of the plate is transferred and taken away by the air/fluid, flowing through the at least one vent, to the environment.

Thus, the cooling system of the present invention allows for transferring heat away from the LEDs/LED area, so that the temperature around the LEDs does not exceed a level above which the function and lifetime of the diodes are unacceptably reduced.

### LED Cooling System

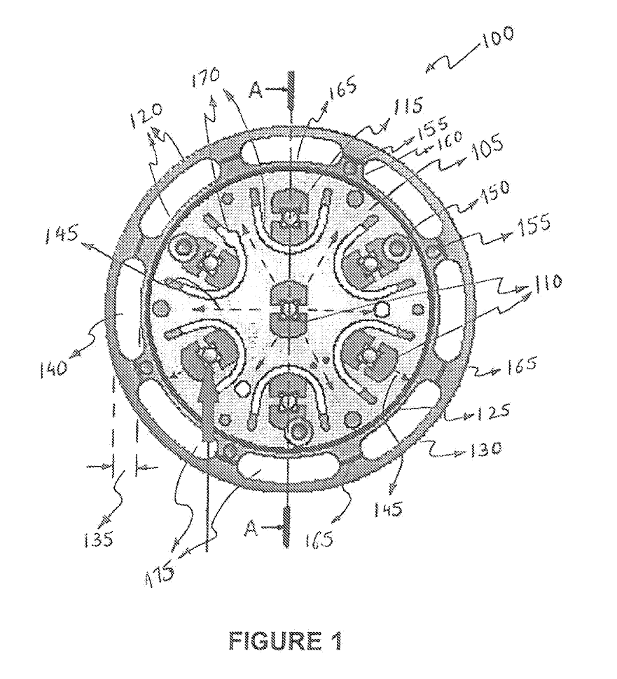

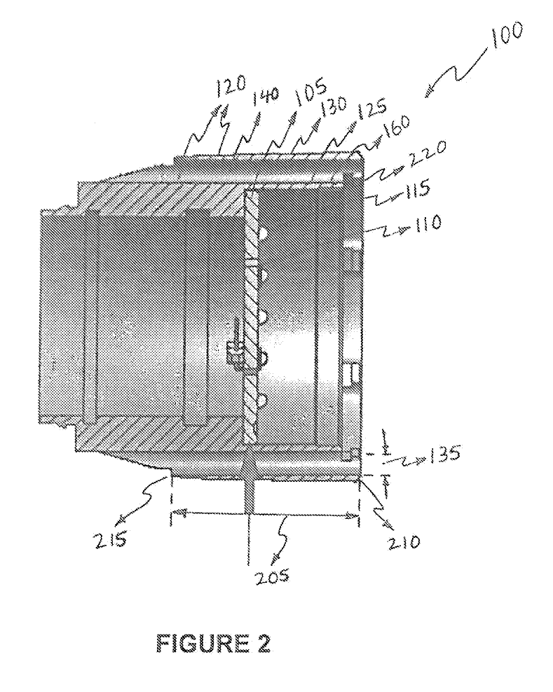

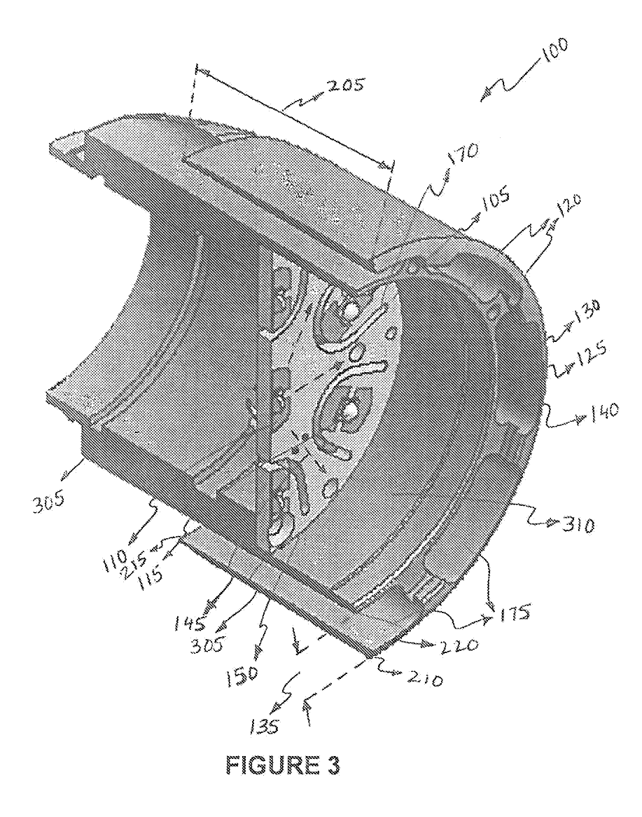

The cooling system is disclosed according to an embodiment, which is illustrated in FIG. 1. Additional features of the system are illustrated in FIGS. 2 and 3 and such components are referred separately throughout the disclosure in appropriate sections. Furthermore, the figures use the same numerals for representing same features of the cooling system.

Referring initially to FIG. 1, an LED cooling system 100 according to an embodiment of the invention is disclosed. The cooling system 100 includes a plate 105, which includes a plurality of slots 110 for positioning a plurality of LEDs 115. The plate further includes at least one gap 170 for substantially isolating each of the plurality of LED slots 110 from one another such that the heat from each of the plurality of LEDs 115 has at least one non-interfering path 145 towards an edge 150 of the plate 105, thereby heating of one LED is substantially uninfluenced by heating of other LEDs of the plurality of LEDs. The non-interfering path is represented by broken line(s) 145 along with direction of flow of heat from the LED/LED area to the edge 150.

In another embodiment of the invention, the cooling system may further include a cover 120, which includes a first cover 125 and a second cover 130. The second cover 130 is fixedly placed, over a part of a length (refer FIGS. 2 and 3, 205) of the first cover, at a radial distance 135 from the first cover 125, thereby defining a radial region 140 between the first cover 125 and the second cover 130 along the part of the length 205.

In yet another embodiment, the first cover 125 holds the plate 105 therein such that the plate is positioned away from the longitudinal ends (refer FIGS. 2 and 3, 210 and 215) of the outer cover 130. Although, the plate may be positioned right next to either of the longitudinal ends but placing the plate away from the longitudinal ends 210 and 215 is preferred because this allows for better air or fluid circulation along the at least one vent 175 in different positions, such as LEDs facing downward, upward, sideward, of the LED device. In other words, positioning the plate away from the longitudinal ends ensures flexibility and reliability while using the LED device.

In another embodiment, at least one divider 165 may divide the radial region 140 into at least one vent 175. The divider runs along the length 205 of the outer cover 130, thereby defining an at least one vent 175 starting at one longitudinal end (refer FIGS. 2 and 3, 210) and ending at another longitudinal end (refer FIGS. 2 and 3, 215) of the outer cover 130. The skilled person may determine the number of dividers needed to produce effective venting. For example, in a portable torch having seven LEDs position on a circular plate, where one LED is surrounded by six other LEDs, as shown in FIG. 1, the cooling system may include 8 dividers, thereby dividing the radial region into 8 vents.

At least one engagement means (refer FIG. 3, 305) such as a guided slot may be provided at an inner surface 310 of the first cover 125 for receiving the edge 150 of the plate 105. In one embodiment, a plurality of engagement means (refer FIG. 3, 305) are provided such that the plurality of engagement means are at different distances from one longitudinal end (refer FIGS. 2 and 3, 220) of the inner cover 125. Depending on the ambient condition and/or lighting application, the plate 105 may be positioned in any of the plurality of the engagement means 305 in order to achieve higher efficiency in heat dissipation.

In an embodiment of the invention, the radial distances at the longitudinal ends (refer FIGS. 2 and 3, 210 and 215) of the outer cover 130 are same. However, in another embodiment, the radial distances at the longitudinal ends 210 and 215 of the outer cover 130 are different. The different radial distances may include a higher radial distance at the longitudinal end 210 relative to that at the longitudinal end 215. Alternatively, the different radial distances may also include a smaller radial distance at the longitudinal end 210 relative to that at the longitudinal end 215. The skilled person would appreciate that the different radial distance at the two longitudinal ends 210 and 215 allows for a varying cross section of the at least one vent, thereby providing nozzle like behaviour in the vent whereby various air/fluid flow characteristics may be controlled for dissipating heat more efficiently.

In an embodiment of the invention, the radial distance is in the range of 3 mm to 7 mm, preferably 4 mm to 6 mm, such as about 5 mm. In an embodiment, the part of a length of the first cover over which the second cover is placed, defining length of the vent, is in the range of 30 mm to 50 mm, preferably 35 mm to 45 mm, more preferably 37 mm to 44 mm such as about 41 mm. The person skilled in the art would appreciate that, depending on the application and environmental conditions, the radial distance and vent length are chosen such that the air/fluid passing through the vent have a laminar or almost laminar flow through the vent, thereby providing an efficient venting.

In various lighting applications such as in diver's torch, it is a requirement that all the components such as LEDs and associated electronics are sealed against water. Similarly, other applications may require air sealed lighting equipment. Therefore, in one embodiment of the invention, the first cover 125 includes a sealing slot (not shown) at its inner surface (refer FIG. 3, 310) for receiving a sealing plate (not shown). The sealing plate seals all the components of the cooling system against weather condition. Understandably, the at least a vent 175 between the first cover 125 and the second cover 130 is not sealed and it still allows flow of air/fluid through itself. In a simple application of this feature, the sealing plate is fitted within the sealing slot with one surface of the sealing plate facing the LEDs 115 and the other surface is facing and exposed to the environment. The sealing plate is made up of a material, which allows for passage of light across itself without noticeable loss of LED illumination properties.

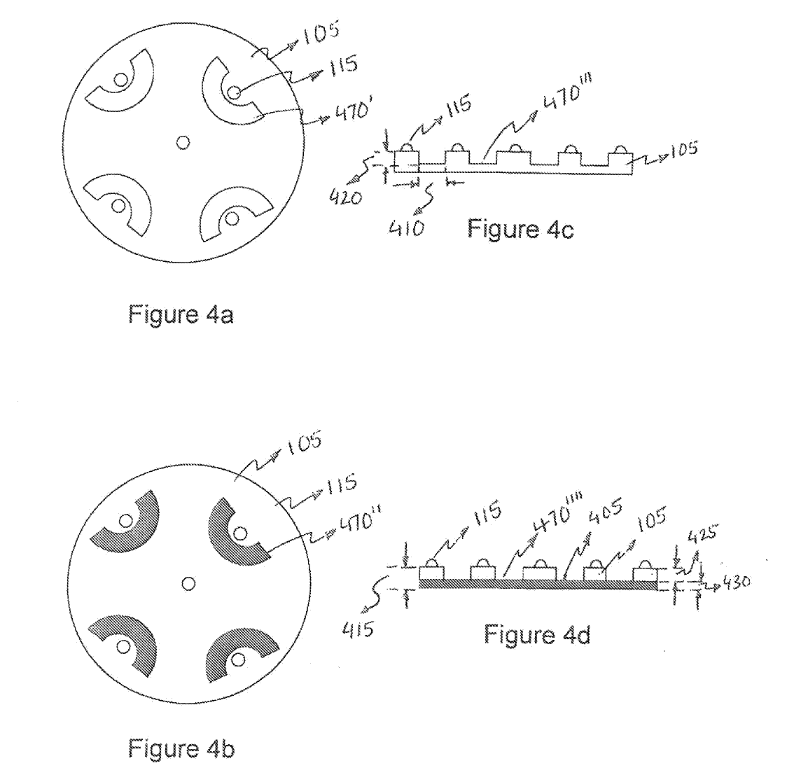

FIG. 4 illustrates the gap according to various embodiments of the invention.

FIG. 4a illustrates a gap, which includes an air gap 470′ according to an embodiment of the invention. In yet another embodiment, the air may be replaced by gases like Argon, which shows lower thermal conductivity than air.

FIG. 4b illustrates a gap with filled in secondary material according to an embodiment of the invention. The gap 470″ may include a secondary material instead of the air opening, which has a lower heat conductivity than that of air in a given application or requirement.

FIG. 4c illustrates a cross-section of a gap, which is a depression in the plate, according to an embodiment of the invention. The gap includes a depression 470′″ of a fixed depth 420 into the plate. The depression reduced the thickness of the plate along the width 410 of the depression. This ensures that the heat carrying capacity of plate is substantially reduced across the width 410 because of the reduced thickness of the plate along the width of the depression.

FIG. 4d illustrates a cross-section of a gap, which is a depression in a multi-layered plate, according to an embodiment of the invention. The plate is made up of two materials across its thickness 415, where one material 105 has substantially higher thermal conductivity relative to the other material 405. The gap includes a depression 470″″ across the entire thickness 425 of the material having substantially higher thermal conductivity. In addition, usually the thickness 430 of the other material is lower than the thickness 425.

The gap typically surrounds an LED. However, an LED (central LED in FIG. 1) may be surrounded by gaps associated with other LEDs (six surrounding LEDs in FIG. 1) as well. Although FIG. 1 illustrates U-shaped gaps 170 but it is understandable that the gaps may also include different shapes. The only criterion is that the gap thermally isolates one LED/LED area from other LEDs/LED areas and therefore, substantially reduces the flow of heat from the LED/LED area across the gap. Thus, the gap allows heat flow path only through the pate, which is made up of a material having thermal conductivity, which is significantly higher in comparison to that of the air, secondary material, plate of reduced thickness or plate of material having substantially reduced thermal conductivity.

In other embodiments, one may also employ a gap, which surrounds more than one LED/LED areas. For example, in FIG. 1, one may employ three gaps, each surrounding two neighbouring peripheral LEDs rather than having six gaps, each surrounding one of the six peripheral LEDs. In a conventional LED layout, which may be identical to FIG. 1 but without the gaps, the central LED is under maximum heat load because of the heat generated by itself and also because of the additive interfering heat load from other six LEDs. Therefore, the skilled person based on the heating of the LED, which is under maximum heat load, may decide the number of gaps and the number of LEDs, surrounded by each of such gaps, to ensure avoidance of LED failure and reliable operation of the LED device.

The width of the gap, according to one embodiment of the invention is in the range of 1 mm to 2.5 mm, preferably 1.3 mm to 2 mm such as about 1.6 mm. The width of the gap is chosen in order to ensure that the heat flow across the gap is nearly zero or insignificant in comparison to the heat flow towards edge of the plate.

The plate, first cover and the second cover are made up of a material having high thermal conductivity and is made up of a metal, such as Aluminium, Copper, Silver, Platinum, Gold, thermal conductive plastic or an alloy having a heat capacity and/or heat conductivity as one of those metals.

The cooling system may also include a connector 155 for connecting the cooling system to a base for a lighting application. In an embodiment, such connector may include a hole at the periphery 160 of the first cover 125 for allowing a fastener to pass through it and for attaching the cooling system 100 to the base using a fastener. Other possible connectors are within the scope of this invention.

In one embodiment of the invention, an LED cooling system is disclosed. The cooling system 100 includes a plate 105 having a slot 110 for positioning an LED 115 and a cover 120 comprising a first cover 125 and a second cover 130. The second cover 130 is fixedly placed over a part of a length 205 of the first cover 125, at a radial distance 135 from the first cover 125, thereby defining a radial region 140 between the first cover 125 and the second cover 130 along the part of the length 205. The radial region 140 is divided into at least one vent 175 and the heat generated by the LED 115 has at least a non-interfering path 145 towards the first cover.

In yet another embodiment, the cooling system further includes a plurality of slots 110 for positioning a plurality of LEDs 115 and at least one gap 170 for substantially isolating each of the plurality of LED slots 110 from one another such that heat from each of the plurality of LEDs 115 has at least one non-interfering path 145 towards an edge 150 of the plate 105/first cover 125, thereby heating of one LED is uninfluential over heating of other LEDs.

The person skilled in the art would appreciate that in for generating a high intensity LED light, there exists a possibility of designing at least two arrangements, which are within the scope of this invention.
First arrangement: Using a large LED light emitting unit. Such large LED light emitting unit includes a large number of LEDs, positioned on a large thermally conducting plate, and having a large LED cooling system; or
Second arrangement: Using a large numbers of smaller LED light emitting units. Such smaller LED light emitting unit includes a plurality of LEDs positioned on a relatively much smaller thermally conducting plate such as the one shown in FIG. 1. The numbers of such smaller LED light emitting units is determined based on the illumination light intensity required and is corresponding to the light intensity produced by the large LED light emitting unit of the first arrangement. In the second arrangement, the farthest LED (for example the central LED in FIG. 1) is much closer to the edge of the plate in comparison to the possible distance of the farthest LED in the first arrangement. Therefore, depending upon the application and environmental condition, one might prefer the second arrangement over the first one.

Therefore, in another embodiment of the invention, a high intensity LED lighting unit is disclosed. The unit includes an array of LED lighting units, wherein each LED lighting unit includes a plate having a plurality of slots for positioning a plurality of LEDs, a cover comprising a first cover and a second cover. The second cover is fixedly placed over a part of a length of the first cover, at a radial distance from the first cover, thereby defining a radial region between the first cover and the second cover along the part of the length, the radial region defining at least one vent and the heat generated by the LED has at least a non-interfering path towards the first cover. The array may include any desired order such as two-dimensional array, where the LED lighting units are placed next to one another in a rectangular or square pattern or circular pattern. Other arrays to produce a specific effect such as for indicating a letter may also be employed.

The high intensity LED lighting unit further includes at least one gap for substantially isolating each of the plurality of LED slots from one another such that heat from each of the plurality of LEDs has at least one non-interfering path towards an edge of the plate/first cover, thereby heating of one LED is substantially uninfluenced by the heating of other LEDs.

It is important to note that FIGS. 1-3 illustrate specific applications and embodiments of the invention, and it is not intended to limit the scope of the present disclosure or claims to that which is presented therein. Throughout the foregoing description, for the purposes of explanation, numerous specific details, such as circular shaped plate, seven LED slots, were set forth in order to provide a thorough understanding of the invention. It will be apparent, however, to one skilled in the art that the invention may be practised without some of these specific details and by employing different embodiments in combination with one another. The underlying principles of the invention may be employed using a virtually unlimited number of different combinations.

Accordingly, the scope and spirit of the invention should be judged in terms of the claims which follow.

1. An LED cooling system having a plate, the plate comprising:
a plurality of slots for positioning a plurality of LEDs; and
at least one gap for substantially isolating each of the plurality of LED slots from one another such that heat from each of the plurality of LEDs has at least one non-interfering path towards an edge of the plate, thereby heating of one LED is substantially uninfluenced by the heating of other LEDs.

2. The cooling system according to claim 1, further comprising a cover comprising a first cover and a second cover, wherein:
the second cover is fixedly placed, over a part of a length of the first cover, at a radial distance from the first cover, thereby defining a radial region between the first cover and the second cover along the part of the length.

3. The cooling system according to claim 1, wherein the first cover holds the plate therein such that the plate is positioned away from longitudinal ends of the outer cover.

4. The cooling system according to claim 1, further comprising at least one engagement means such as a guided slot at an inner surface of the first cover for receiving the edge of the plate.

5. The cooling system according to claim 1, wherein the at least one engagement means are at different distances from one longitudinal end of the inner cover.

6. The cooling system according to claim 1, further comprising at least one divider for dividing the radial region, the divider running along the length of the outer cover, thereby defining an at least one vent starting at one longitudinal end and ending at another longitudinal end of the outer cover.

7. The cooling system according to claim 1, wherein the radial distances at the longitudinal ends of the outer cover is selected from a group consisting of same radial distance and different radial distances.

8. The cooling system according to claim 1, further comprising a sealing slot at the inner surface of the first cover for receiving a sealing plate for sealing all the components of the cooling system except the at least a vent between the first cover and the second cover.

9. The cooling system according to claim 1, wherein the radial distance is in the range of 3 mm to 7 mm.

10. The cooling system according to claim 1, wherein width of the gap is in the range of 1 mm to 2.5 mm.

11. The cooling system according to claim 1, wherein the plate, the first cover and the second cover are made up of a material having a high thermal conductivity and is selected from a group consisting of aluminium, copper, silver, platinum, gold, and thermal conductive plastic.

12. The cooling system according to claim 1, further comprising at least one connector for connecting the cooling system to a base for a lighting application.

13. A cover for cooling LED, comprising:
a first cover and a second cover, wherein:
the second cover is fixedly placed over a part of a length of the first cover, at a radial distance from the first cover, thereby defining a radial region between the first cover and the second cover along the part of the length, the radial region defining at least one vent.

14. (canceled)

15. An LED cooling system, comprising:
a plate having a slot for positioning an LED;
a cover comprising a first cover and a second cover, wherein:
the second cover is fixedly placed over a part of a length of the first cover, at a radial distance from the first cover, thereby defining a radial region between the first cover and the second cover along the part of the length, the radial region defining at least one vent; and wherein
the heat generated by the LED has at least a non-interfering path towards the first cover.

16. The cooling system according to claim 15, further comprises:
a plurality of slots for positioning a plurality of LEDs; and
at least one gap for substantially isolating each of the plurality of LED slots from one another such that heat from each of the plurality of LEDs has at least one non-interfering path towards an edge of the plate/first cover, thereby heating of one LED is substantially uninfluenced by heating of other LEDs.

17. (canceled)

18. A high intensity LED lighting unit, comprising:
an array of LED lighting units, wherein each LED lighting unit comprises:
a plate having a plurality of slots for positioning a plurality of LEDs,
a cover comprising a first cover and a second cover, wherein the second cover is fixedly placed over a part of a length of the first cover, at a radial distance from the first cover, thereby defining a radial region between the first cover and the second cover along the part of the length, the radial region defining at least one vent; and
the heat generated by the LED has at least a non-interfering path towards the first cover.

19. (canceled)
